(19) United States
(12) Patent Application Publication
(10) Pub. No.: US 2014/0030521 A1
(43) Pub. Date: Jan. 30, 2014

(54) ADDITIVE COMPOSITIONS FOR LOW LOSS WIRE AND CABLE DIELECTRIC AND PRODUCTS OBTAINED THEREBY

(71) Applicant: REEDY INTERNATIONAL CORPORATION, Keyport, NJ (US)

(72) Inventor: Michael E. REEDY, Keyport, NJ (US)

(73) Assignee: REEDY INTERNATIONAL CORPORATION, Keyport, NJ (US)

(21) Appl. No.: 13/951,198

(22) Filed: Oct. 15, 2013

Related U.S. Application Data
(60) Provisional application No. 61/676,616, filed on Jul. 27, 2012.

(51) Int. Cl. H01B 3/44

(52) U.S. Cl. CPC H01B 3/441
USPC 428/379; 521/143; 428/375

(57) ABSTRACT

There are disclosed additive compositions for polymer base materials, which additive compositions are comprised of blowing agent (direct gas or chemical blowing agent), thermoplastic polymer carrier for the chemical blowing agent and filler, wherein the thermoplastic polymer carrier has a melting point below the decomposition temperature of the chemical blowing agent. The chemical blowing agent can be selected from those based on hydrazine, hydrazide, or azodicarbonamide, or those based on combinations of sodium citrate/citric acid and sodium bicarbonate. The filler can be selected from calcium carbonate, zeolites, clay and other known fillers. The polymer base sheet material can be, e.g., polyethylene, polypropylene, polybutylene, poly (p-phenylene oxide), polystyrene and combinations thereof. If direct gas blowing agent is used, then the compositions should contain a nucleating agent which may or not be the same as the chemical blowing agent.

### CROSS-REFERENCED APPLICATION

This application is related, and claims priority, to U.S. Provisional Application No. 61/676,616, filed on Jul. 27, 2012 that is incorporated herein in its entirety by reference thereto.

### BACKGROUND

1. Field of Disclosure

The disclosure describes novel blowing agent formulations which are useful in nucleating polymer foam compositions. The disclosed blowing agent formulations should find particular use in areas where the foamed material is used in applications where high dielectric constants, low loss factors and low densities are preferred, such as in applications involving wire and cable dielectric materials. The nucleating agents of the present disclosure provide density reduction in the foamed materials as blowing agents and allow for density reductions of the dielectric materials with improved, or without adversely affecting, dielectric properties.

2. Background of the Disclosure

It has been speculated about how to unitize the microcellular foaming technology in coaxial cable applications. In Lorenz, et al., High-frequency Coaxial Cable-An Application of Microcellular Foaming Technology in Extrusion, Blowing Agents and Foaming Processes, paper 21, Stuttgart, Germany 2005, some preliminary work is disclosed in which the authors speculate about methods and apparatuses to attain microcellular foams which may find use in coaxial cable applications. Therein, the use of nucleating agents are said to provide too few nucleating sites and, inter alia, direct gas foaming is used.

In a non-foam application in polyvinyl chloride polymer (PVC), Azmi, Mohd Asyraf Reduan, The Effect of Calcium Carbonate and Calcined Clay Micro Filler Materials on the Electric Characteristics of Polyvinyl Chloride for Cable Insulation, Master of Engineering Thesis, Universti Teknologi Malaysia, May 2008, the use of 10% CaCO₃ in PVC is preferred for the filler because “after the highest value [of density], the dielectric strength started to show degradation characteristic even though the density kept increasing”.

### SUMMARY

According to the present disclosure, there is provided, in one of its aspects, additive compositions for polymer base materials, which additive compositions are comprised of a blowing agent (direct gas or chemical blowing agent), a thermoplastic polymer carrier for the chemical blowing agent, and a filler, wherein the thermoplastic polymer carrier has a melting point below the decomposition temperature of the chemical blowing agent. Preferably, if used, the chemical blowing agent can be selected from those based on hydrazine, hydrazide, or azodicarbonamide, or those based on combinations of sodium citrate/citric acid and sodium bicarbonate. Also preferably, the filler can be selected from calcium carbonate, zeolites, clay and other known fillers. Preferably, the polymer base material can be selected from polyethylene (PE, including LLDPE, HDPE and all other grades of PE), polypropylene (PP), polyvinyl chloride (PVC), polybutylene (PB), poly (p-phenylene oxide) (PPO) (or poly (p-phenylene ether) (PPE)), polystyrene (PS), high impact polystyrene (HIPS) and acrylonitrile butadiene styrene (ABS). Also as the polymer base for the material there can be used metallocene-based polymers and/or copolymers of the same. If direct gas blowing agent is used, then the compositions should contain a nucleating agent which may or not be the same as the chemical blowing agent.

In another of its aspects, the present disclosure provides for a foamed material comprised of polymer base material and an additive composition comprised of (when chemical blowing agent is used) the residue of chemical blowing agent, thermoplastic polymer carrier for the chemical blowing agent, and filler. Again, the thermoplastic polymer carried has a melting point below the decomposition temperature of the chemical blowing agent.

In another of its aspects, the present disclosure provides for a foamable composition suitable for forming into a foamed rod, coating or tube, the foamable composition comprised of polymer base material and an additive composition comprised of chemical blowing agent, thermoplastic polymer carrier for the chemical blowing agent, and filler, wherein the thermoplastic polymer carried has a melting point below the decomposition temperature of the chemical blowing agent. The foamable composition can be polymer base material, separate from the additive composition, and the additive composition added thereto at the site of production of the foamed material, or the foamable composition can be pre-production combination comprised of polymer base material, chemical blowing agent (or nucleating agent), thermoplastic polymer carrier for the chemical blowing agent (or nucleating agent), and filler, wherein the thermoplastic polymer carrier has a melting point below the decomposition temperature of the chemical blowing agent (or nucleating agent).

In still another of its aspects, the present disclosure provides for a composite comprised of: a core comprised of metallic or non-metallic conductive wire or cable, and a covering for the core, said covering comprised of: foamed polymeric material comprised of polymer base material and an additive composition comprised of: residue of chemical blowing agent, thermoplastic polymer carrier for the chemical blowing agent, and filler.

In other aspects, direct gas foaming can be provided for in any of the above embodiments, and the starting and final compositions will be altered accordingly, as will become apparent based on the following detailed disclosure.

These and other aspects of the present disclosure will become known to those of skill in the art based upon the detailed description which follows.

### BRIEF DESCRIPTION OF THE FIGURE

FIG. 1 is a graph showing comparisons in volume resistivities of compositions using the additives of the present disclosure compared to compositions using state of the art additives.

### DETAILED DESCRIPTION OF THE DISCLOSURE

As mentioned above, in a first embodiment, there are provided additive compositions comprised of a master batch of: chemical blowing agent, thermoplastic polymer carrier for the chemical blowing agent, and filler, wherein the thermoplastic polymer carrier has a melting point below the decomposition temperature of the chemical blowing agent. Also as mentioned above, there can be used direct gas applications, in which case, in the additive compositions, the chemical blowing agent can act as both a blowing agent or, preferably, as a nucleating agent and contributing to only a minor portion of the production of cells during foam making.

The first component of the master batch of the present disclosure is a chemical blowing agent, also known as solid blowing agent, which releases a gas upon reaching its decomposition temperature. The solid blowing agent can be any of the known chemical blowing agents such as those based on hydrazine, hydrazide, or azodicarbonamide, or those based on combinations of solid organic acids (or a metal salt thereof) and alkali metal carbonate(s) or alkali metal bicarbonate(s), such as combination of sodium citrate/citric acid and sodium bicarbonate.

The solid blowing agents that can be used in the master batch can include mixtures of one or more solid organic acids, for example, oxalic acid, succinic acid, adipic acid, phthalic acid and, preferably, citric acid; and an alkali metal carbonate or alkali metal bicarbonate, for example, sodium carbonate, potassium carbonate and, preferably, sodium bicarbonate. The acid and carbonate and/or bicarbonate are generally used in alkali:acid equivalent ratios of from about 1:3 to about 3:1, acid to carbonate (and/or bicarbonate), and are preferably used in approximate stoichiometric amounts, i.e. about 0.7 to 1.3 alkali equivalents per acid equivalent, preferably about 0.9 to 1.1 alkali equivalents per acid equivalent. Especially preferred as the solid blowing agent of the master batch mix are combinations of monosodium citrate and sodium bicarbonate, the amounts of monosodium citrate and sodium bicarbonate present preferably also as an approximate stoichiometric mixture.

Also preferred as solid blowing agents are the SAFOAM P and SAFOAM FP powders, available from Reedy International Corporation, Keyport, N.J. SAFOAM P-20 and SAFOAM FP-20 contain about 19.8% of an equimolar combination of monosodium citrate and sodium bicarbonate encapsulated in vegetable oil (SAFOAM P and SAFOAM FP, respectively, a combination of 14% mono-, 12% di-, and 72% triglycerides), 67.5% of alpha-methyl styrene (Plastolyn 290 from Eastman Chemicals), about 10% of a combination of styrene-ethylene/propylene block copolymer (Shell Chemical Company, Kraton G-1726×) and styrene-ethylene/butylene-styrene block copolymer (Shell Chemical Company, Kraton G-1650), about 2.5% of white mineral oil, and about 0.2% of silica (predominantly present as a dusted coating on the outside of pellets made from the remaining ingredients). SAFOAM FP-40 contains about 38.8% of an equimolar combination of monosodium citrate and sodium bicarbonate encapsulated in vegetable oil (SAFOAM FP, available from Reedy International Corporation), 36.6% of alpha-methyl styrene (Plastolyn 290 from Eastman Chemicals), 14.4% of styrene-ethylene/butylene-styrene block copolymer (Shell Chemical Company, Kraton G-1652), about 9.0% of white mineral oil and about 0.2% silica. SAFOAM P-50 comprises about 54.8% of an equimolar combination of monosodium citrate and sodium bicarbonate encapsulated in vegetable oil (SAFOAM P, available from Reedy International Corporation), about 30.5% of alpha-methyl styrene (Plastolyn 290 from Eastman Chemicals), about 12% of styrene-ethylene/butylene-styrene block copolymer (Shell Chemical Company, Kraton G-1650), about 7.5% of white mineral oil, and about 0.2% of silica.

Again, if direct gas foaming is used, any of the above chemical blowing agents can act alternatively as nucleating agents, as can talc, clay, zeolite, and the like, all preferably in particle sizes of 100 microns or less, preferably 50 microns or less, and more preferably of nanoparticluate size.

The second component of the master batch of the present disclosure is a thermoplastic polymer carrier for the chemical blowing agent. As mentioned above, the only requirement for the thermoplastic polymer carrier is that it melts below the decomposition temperature of, when used, the solid blowing agent. Preferably, the melt temperature of the thermoplastic polymer carrier will be between about 100° C. to about 170° C., more preferably between about 100° C. to about 160° C., especially preferably between about 120° C. and 140° C., and most preferably below about 120° C. At the present time, highly branched polyolefin(s) produced in a tubular or autoclave system work the best for this the thermoplastic polymer carrier.

The third component of the master batch of the present disclosure is filler. As mentioned above, the filler can be selected from calcium carbonate, zeolites, clay, hallocytes and other known fillers. Preferably, the filler has a particle size in the range of from about 1 to about 20 microns; more preferably of from about 2 to about 10 microns and, most preferably, the particle size of the filler is between about 3-5 microns. Preferably, the filler is calcium carbonate having a particle size range of about 2 to about 10 microns. Most preferred at this time is calcium carbonate available from OMYA, Inc., and most preferably the calcium carbonate is OMYACARB 3, which has an average particle size of about 3 microns.

According to the present disclosure, the solid blowing agent (nucleating agent when direct gas is used as the blowing agent), can be present in an amount of from about 2% to about 25% by weight, based upon 100% by weight of the total filler composition, preferably from about 3% to about 12% by weight, more preferably from about 8% to about 10% by weight. When a combination of sodium bicarbonate and monosodium citrate are used, the amount of the sodium bicarbonate can be in the range of from about 2% to about 10%, preferably of from about 3% to about 5%, and the amount of monosodium citrate can be of from about 4% to about 15%, preferably of from about 5% to about 7% and most preferably about 6%, based on 100% by weight of the total filler composition. When the solid blowing agent/nucleating agent is a SAFOAM, the weight percentages can be of from about 5% to about 25%, preferably of from about 8% to about 15%, and most preferably of from about 10% to about 12%, based on 100% by weight of the total filler composition. Also according to the present disclosure, the thermoplastic polymer carrier can be present in an amount of from about 30% to about 60%, preferably of from about 35% to about 55%, more preferably of from about 40% to about 45%, based on 100% by weight of the total filler composition. Finally, the filler can be present can be present in an amount of from about 30% to about 60%, preferably of from about 35% to about 55%, more preferably of from about 40% to about 45%, based on 100% by weight of the total filler composition.

As mentioned above, the polymer base material can be selected from polyethylene (PE, including LLDPE, HDPE and all other grades of PE), polypropylene (PP), polybutylene (PB), poly (p-phenylene oxide) (PPO) (or poly (p-phenylene ether) (PPE)), poly alkenyl aromatic polymers such as polystyrene (PS), high impact polystyrene (HIPS) and acrylonitrile butadiene styrene (ABS). The polymer base material can be present in an amount of from about 50% or more of the total amount of polymer base material plus other components, preferably more than about 70%, more preferably more than about 80% and most preferably of form about 85%-95%. In some applications, greater or less polymer base material can be used.

Polyethylene (abbreviated PE) is one of the most common thermoplastics. Many kinds of polyethylene are known, but almost always have the chemical formula (C₂H₄)ₙH₂. Thus, PE is usually a mixture of similar organic compounds that differ in terms of the value of “n”. Polyethylene is a thermoplastic polymer consisting of long hydrocarbon chains. Depending on the crystallinity and molecular weight, a melting point and glass transition may or may not be observable. The temperature at which these occur varies strongly with the type of polyethylene. For common commercial grades of medium- and high-density polyethylene the melting point is typically in the range 120° C. to 130° C. (248° F. to 266° F.). The melting point for average, commercial, low-density polyethylene is typically 105° C. to 115° C. (221° F. to 239° F.).

Polypropylene (PP) is an addition polymer made from the monomer propylene; it is rugged and unusually resistant to many chemical solvents, bases and acids. Polypropylene is also used as an alternative to polyvinyl chloride (PVC) as insulation for electrical cables for cable in low-ventilation environments, primarily tunnels. This is because it emits less smoke and no toxic halogens, which may lead to production of acid in high-temperature conditions.

Polyvinyl chloride, commonly abbreviated PVC, is the third-most widely produced plastic after polyethylene and polypropylene. PVC is used in construction because it is cheaper than stronger and more traditional alternatives such as copper or ductile iron. It can be made softer and more flexible by the addition of plasticizers, the most widely used being phthalates. In this form, it is used in clothing and upholstery, electrical cable insulation, inflatable products and many applications in which it replaces rubber. Polyvinyl chloride is produced by polymerization of the monomer vinyl chloride. The polymers are linear. The monomers are mainly arranged head-to-tail, meaning that there are chlorides on alternating carbon centers. PVC has mainly an atactic stereochemistry, which means that the relative stereochemistry of the chloride centers is random. Some syndiotacticity of the chain provides crystallinity that is influential on the properties of the material. About 57% of the mass of PVC is chlorine. The presence of chloride groups gives the polymer very different properties from the structurally related material polyethylene.

Polybutylene is a polyolefin or saturated polymer with the chemical formula (C₄F₈)ₙ. Polybutylene is produced by polymerization of 1-butene using supported Ziegler-Natta catalysts. Polybutylene is a high molecular weight, linear, isotactic, and semi-crystalline polymer. Polybutylene combines typical characteristics of conventional polyolefin with certain properties of technical polymers. Polybutylene, when applied as a pure or reinforced resin, can replace materials like metal, rubber and engineering polymers. It is also used synergistically as a blend element to modify the characteristics of other polyolefin such as polypropylene and polyethylene.

Poly (p-phenylene oxide (PPO, or poly (p-phenylene ether) (PPE)) is a high-temperature thermoplastic. It is rarely used in its pure form due to difficulties in processing. It is mainly used as a blend with polystyrene, high impact styrene-butadiene copolymer or polyamide. PPE is an amorphous high-performance plastic. The glass transition temperature is 215° C., but the glass transition temperature can be varied by mixing with polystyrene. Through modification and the incorporation of fillers such as glass fibers, the properties can be extensively modified.

The poly alkenyl aromatic polymers can be, for example, styrene polymers. The styrene polymers included in the compositions of the invention are homo polymers of styrene, and copolymers and inter polymers of styrene containing a predominant proportion of styrene, e.g. greater than 50 weight percent and, preferably, greater than 75 weight percent, styrene. Examples of monomers that may be inter polymerized with the styrene include alpha, beta-unsaturated monocarboxylic acids and derivatives thereof, e.g. acrylic acid, methyl acrylate, ethyl acrylate, butyl acrylate, 2-ethylhexyl acrylate and the corresponding esters of methacrylic acid, acrylamide, methacrylamide, acrylonitrile, methacrylonitrile, maleic anhydride, etc. If desired, blends of the styrene polymer with other polymers may be employed, e.g. blends of the styrene polymer with grafted rubbery diene polymers, or the analogous compositions obtained by dispersing a rubber diene polymer in the styrene monomer and, optionally, other monomers, and subsequently polymerizing the mixture. In any of the above type resins, all or a portion of the styrene may be replaced with its closely related homologues such as alpha-methylstyrene, o-, m-, and p-methylstyrenes, o-, m-, and p-ethylstyrenes, 2,4-dimethylstyrene, bromostyrene, chlorostyrene, and the like. Copolymers of alkenyl aromatic, e.g. styrene, and alkenyl nitrile, e.g., acrylonitrile can also be used and can have a weight ratio of styrene to acrylonitrile of 95:5 to 5:95 respectively.

The compositions can also contain other additives, such as: anti-counterfeiting agents, antioxidants, antistatic agents, external lubricants, heat and light stabilizers, pigments, plasticizers, process aids, reinforcements, flame retardants, moisture scavengers and others know to those of skill in the art. In some applications, such as in the production of foamed materials for cable and wire applications, antioxidants may be required. The amount of other additive can be any effective amount, as needed. In particular, the other additives, alone or in combination, can be in the range of from about 0.01%-20%, preferably in the range of from about 0.01%-10%, more preferably in the range of from about 1%-20%, especially preferably in the range of from about 2%-10%, and most preferably in the range of from about 3%-8%

The following example shows the benefits of the embodiments of the present disclosure.

Additive composition A (the present disclosure)

| | |
|---|---|
| LDPE¹ | 44.00% |
| Sodium Bicarbonate | 4.00% |
| Monosodium Citrate | 6.00% |
| Irganox 802 FL* | 1.00% |
| OMYACARB 3** | 40.00% |
| Morcal 90*** | 1.00% |
| DUOPRIME**** | 4.00% |
| | 100.00% |

¹At 190 (LDPE) OSC Melt Temperature 102° C. (ASTM 03418)
*Propanoic Acid 3.3′-Thio-Bis-Dioctyldecyl Ester
**Calcium Carbonate
***Calcium Oxide
****White Mineral Oil

Blend 3 (the present disclosure)

| | |
|---|---|
| PP | 20% |
| HDPE | 75% |
| Additive composition A | 5% |
| | 100% |

Blend 4 (the present disclosure)

| | |
|---|---|
| PP | 97% |
| Additive composition A | 3% |
| | 100% |

Comparative Blend 1

| | |
|---|---|
| PP | 20% |
| HDPE | 75% |
| Chemical blowing agent | 5% |
| | 100% |

Comparative Blend 2

| | |
|---|---|
| PP | 97% |
| Chemical blowing agent | 3% |
| | 100% |

Control 1

| | |
|---|---|
| HDPE | 75% |
| PP | 25% |
| | 100% |

Control 2

| | |
|---|---|
| PP | 100% |

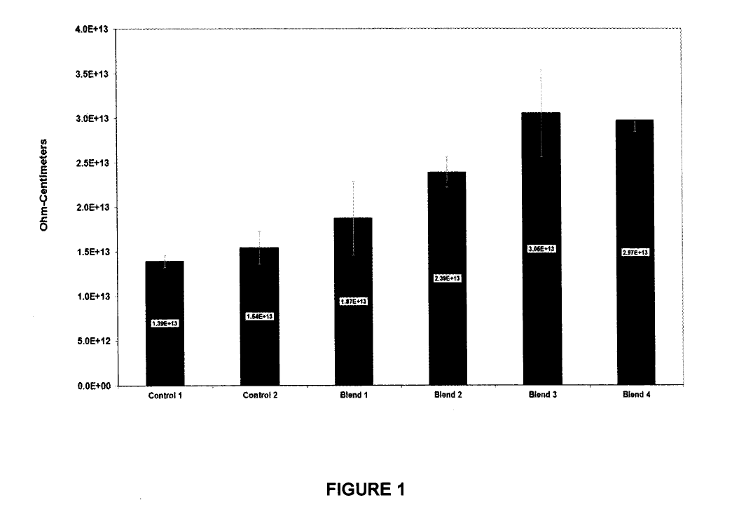

The above compositions were evaluated for volume resistivity and the results are shown in the graph in FIG. 1. As can be seen in FIG. 1, the blends according to the present disclosure have volume resistivity of at least about 3.0 ohm-centimeter, while the blends using no additive (Controls 1 and 2) or state of the art additive/blowing agents (Blends 1 and 2) attain a volume resistivity of no greater than about 2.4 ohm-centimeter.

While the disclosure has been described with reference to embodiments, it will be understood by those skilled in the art that various changes may be made and equivalents may be substituted for the elements thereof without departing from the scope of the disclosure. In addition, many modifications may be made to adapt the teaching of the disclosure to particular use, application, manufacturing conditions, use conditions, composition, medium, size, and/or materials without departing from the essential scope thereof. Therefore, it is intended that the disclosure not be limited to the particular embodiments and best modes contemplated for carrying out this disclosure as described herein. The accompanying claims are intended to cover such modifications as would fall within the true scope and spirit of the present disclosure. All of the patents and publications referenced herein are intended to be incorporated herein by reference for all of the information contained therein.

What is claimed is:

1. An additive composition for polymer base materials, the additive composition comprised of:
a direct gas or chemical blowing agent;
a thermoplastic polymer carrier for the chemical blowing agent; and
a filler,
wherein the thermoplastic polymer carrier has a melting point below the decomposition temperature of the chemical blowing agent.

2. A foamable composition comprised of:
polymer base material; and
an additive composition comprised of: chemical blowing agent, thermoplastic polymer carrier for the chemical blowing agent, and filler,
wherein the thermoplastic polymer carried has a melting point below the decomposition temperature of the chemical blowing agent.

3. A composite comprised of:
a core comprised of metallic or non-metallic conductive wire or cable; and
a covering for the core, the covering comprised of: foamed polymeric material comprised of polymer base material and an additive composition comprised of: residue of chemical blowing agent, thermoplastic polymer carrier for the chemical blowing agent, and filler.

4. A method of improving the dielectric properties of a foamed material, the method comprising:
providing a base polymer, the base polymer being foamable;
adding to the base polymer an additive comprised of:
a direct gas or chemical blowing agent;
a thermoplastic polymer carrier for the chemical blowing agent; and
a filler,
wherein the thermoplastic polymer carrier has a melting point below the decomposition temperature of the chemical blowing agent to form a base polymer blend; and
foaming the polymer blend.
